(19) United States
(12) Patent Application Publication
(10) Pub. No.: US 2013/0119095 A1
(43) Pub. Date: May 16, 2013

(54) FASTENING ADAPTER FOR A SPARE WHEEL OF A VEHICLE AND FASTENING DEVICE

(71) Applicants: Guenter SCHERRER, Floersheim (DE); Oliver MEULBROUCK, Riedstadt-Crumstadt (DE)

(72) Inventors: Guenter SCHERRER, Floersheim (DE); Oliver MEULBROUCK, Riedstadt-Crumstadt (DE)

(73) Assignee: GM GLOBAL TECHNOLOGY OPERATIONS LLC, Detroit, MI (US)

(21) Appl. No.: 13/464,064

(22) Filed: May 4, 2012

(30) Foreign Application Priority Data
May 6, 2011 (DE) 10 2011 100 704.4

(51) Int. Cl. B62D 43/06

(52) U.S. Cl. CPC B62D 43/06
USPC 224/42.24

(57) ABSTRACT

A fastening adapter for fastening a spare wheel in a spare wheel recess of a vehicle is provided. The fastening adapter has a conical section with an opening for guiding a fastening element therethrough. The longitudinal axis of the conical section is offset to a longitudinal axis of the opening.

### CROSS-REFERENCE TO RELATED APPLICATION

This application claims priority to German Patent Application No. 10 2011 100 704.4 filed May 6, 2011, which is incorporated herein by reference in its entirety.

### TECHNICAL FIELD

The technical field generally relates to a fastening adapter for a spare wheel of a vehicle, in particular of an automobile, and a fastening device.

### BACKGROUND

In the German patent DE 199 60 069 C1 a device is disclosed for fastening a spare wheel in an automobile. The device has at least one fastening bolt and an attached pressure element that lies against a tensioning element on the fastening bolt and engages onto the edge of a wheel hub of the rim of the wheel after the fastening of the fastening bolt on the holder.

In order to fulfill the requirements in a vehicle of an impact test from the rear, it is necessary that the spare wheel does not inadvertently become detached on an impact from the rear. For this, a spare wheel has hitherto been additionally secured in the vehicle by bands. However, this is complex and laborious in handling for a user

### SUMMARY

An improved fastening adapter is provided. A spare wheel, the center of which is offset to a fastening point for a fastening bolt in the spare wheel mount, can be fastened by the fastening adapter. The fastening adapter can balance out this offset owing to its conical section which is not provided centrally to the opening of the fastening adapter, but rather is offset thereto. Furthermore, the conical section of the adapter makes it possible that the spare wheel can tilt around the fastening bolt in the case of an impact, so that the forces onto the fastening bolt can be reduced and a breaking off of the fastening bolt can be counteracted.

The fastening adapter on the one hand enables the fastening of a spare wheel in a spare wheel mount, when the center of the rim of the spare wheel does not coincide with the fastening point of the fastening bolt in the spare wheel mount, but rather is offset hereto. This is achieved by the longitudinal axis of a conical section of the adapter, which is inserted into the rim, being offset to the longitudinal axis of the opening of the adapter, in which the fastening bolt is introduced. Furthermore, the conical section of the adapter allows the spare wheel to be able to tilt around the fastening bolt by which the spare wheel is fastened in the spare wheel mount, in the case of an impact onto the vehicle. Thereby, the fastening bolt is less intensively stressed and a tearing off of the fastening bolt in the case of a crash is counteracted.

In an embodiment, the opening of the fastening adapter has a mount, in particular a conical section, for receiving a fastening nut. Through the mount for receiving the fastening nut, the fastening adapter can be additionally guided through the fastening nut.

In a further embodiment, the opening of the fastening adapter has a cylindrical section for guiding a fastening bolt which is introduced into the opening. Thereby, the fastening adapter is guided automatically on pushing onto the fastening bolt and cannot tip inadvertently.

According to another embodiment, the fastening adapter has several reinforcing ribs. The fastening adapter can be configured so as to be hollow, whereby the formation of cavities can be counteracted and at the same time a stable structure can be achieved. In a further embodiment, the reinforcing ribs are connected with each other via an inner wall and project over the inner wall with their ends, in order to form the conical section for receiving the fastening nut, or terminate with the inner wall with their ends, wherein the inner wall forms the conical section for receiving the fastening nut. By the connecting of the reinforcing ribs by the inner wall, an inadvertent bending up of the ribs can be counteracted and a particularly stable structure can be achieved.

The inner wall and/or the reinforcing ribs form a support for the fastening nut, in another embodiment. Thereby, on screwing the fastening nut into the fastening adapter, this force can be applied via the support onto the inner wall or respectively the reinforcing ribs of the fastening adapter and can press the latter securely against a rim of a spare wheel.

According to further embodiment, the fastening adapter is constructed as a cast part or injection molded part, in particular of metal or plastic. In this regard, the adapter can be produced at a favorable price as an injection molded part.

The above embodiments and further developments can be combined with each other as desired, in so far as this is expedient. Further possible embodiments, further developments and implementations also comprise combinations, not explicitly named, of features described previously or below with respect to the example embodiments. In addition, other objects, desirable features and characteristics will become apparent from the subsequent detailed description, and the appended claims, taken in conjunction with the accompanying drawings and this summary.

### BRIEF DESCRIPTION OF THE DRAWINGS

The various embodiments will hereinafter be described in conjunction with the following drawing figures, wherein like numerals denote like elements, and wherein:

FIG. 1 is a top view of a spare wheel recess of a vehicle, in which a spare wheel is held;

FIG. 2 is an enlarged cutout of the spare wheel in the spare wheel mount;

FIG. 3 is a top view onto the spare wheel recess according to FIGS. 1 and 2, wherein the spare wheel is fastened in the spare wheel recess on the vehicle by means of a fastening device in accordance with an exemplary embodiment;

FIG. 4 is a perspective view, partially in section, of the fastening of the spare wheel according to FIG. 3 by means of the fastening device in accordance with an exemplary embodiment;

FIG. 5 is a perspective view of the fastening adapter of the fastening device of FIG. 4

FIG. 6 is a top view of the fastening adapter according to FIG. 5; and

FIG. 7 is a side view of the fastening adapter according to FIGS. 5 and 6.

### DETAILED DESCRIPTION

The following detailed description is merely exemplary in nature and is not intended to limit the application and uses of the various embodiments. Furthermore, there is no intention to be bound by any theory presented in the preceding background or the following detailed description.

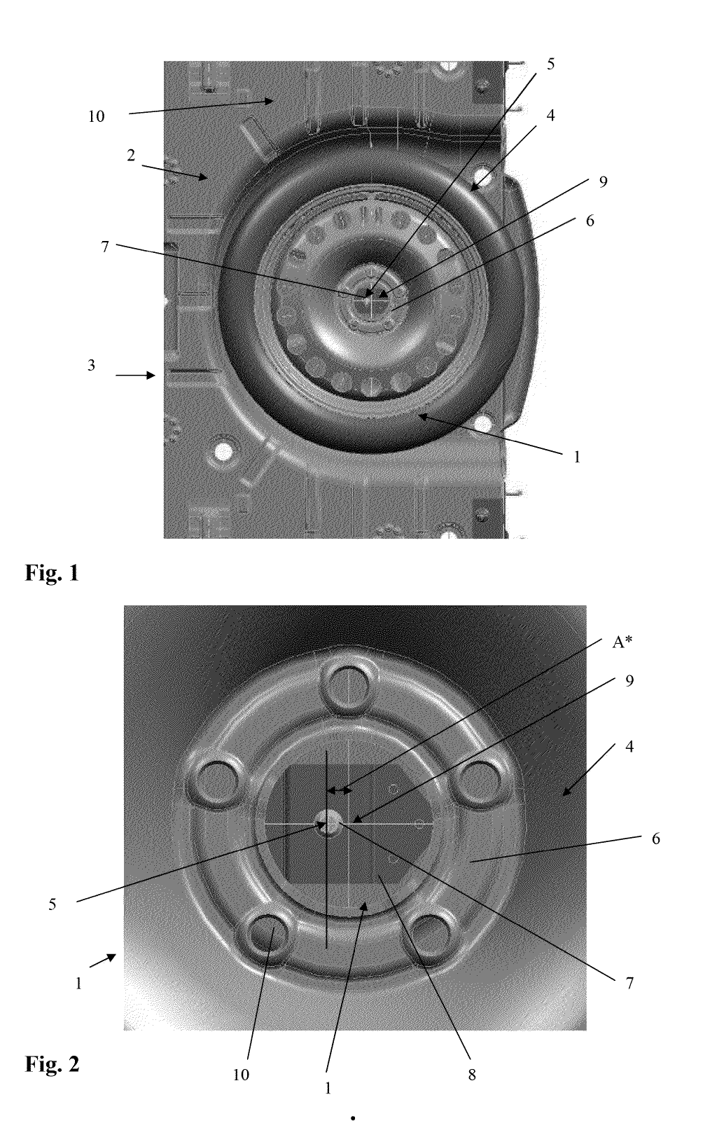

In FIG. 1 a top view is shown of a spare wheel recess 1, for example a spare wheel depression in the trunk 2 of a vehicle 3, in which a spare wheel 4 is held. The spare wheel 4 is normally arranged in a well on the base side, such as e.g. the spare wheel depression shown in FIG. 1, or in a side wall in the trunk of a vehicle. Usually, the vehicle 3 can be laden with various spare wheels which can have different tires and/or different rims. Owing to the different spare wheels, it can occur that the spare wheel 4 cannot be arranged centrally to the fastening point 5 of the spare wheel recess 1 in the vehicle 3. Therefore, in such a case, the spare wheel 4 cannot be readily fastened or secured to the vehicle 3.

In the example shown in FIG. 1, the spare wheel 4 with its rim 6 is not able to be arranged centrally or respectively at a distance A from a fastening point 5 of the spare wheel recess 1, in which a fastening bolt 7 is fastened, for example detachably fastened. In the example embodiment shown in FIG. 1, the fastening bolt 7 is fastened, for example is detachably fastened, on a holder 8 of the spare wheel recess 1. Thereby, the spare wheel 4 cannot be fastened simply in the spare wheel recess 1 on the fastening bolt 7 by screwing on a corresponding nut (not illustrated).

FIG. 2 shows an enlarged cutout of the spare wheel 4 in the spare wheel recess 1 according to FIG. 1. Here, the center 9 of the rim 6 of the spare wheel 4 is situated eccentrically to the fastening bolt 7. The center 9 of the rim 6 is spaced at a distance A to the fastening point 5, in which the fastening bolt 7 is fastened on the spare wheel recess 1. In the example embodiment in FIGS. 1 and 2, the fastening bolt 7 is fastened on the holder 8, which in turn is fastened on a base plate 10, which forms a base well with a corresponding depression to receive the spare wheel 4 in the vehicle 3. As is shown in the following FIG. 4, the holder 8 has for example a bore with a thread section, into which the fastening bolt 7 is able to be screwed.

In the example embodiment shown in FIGS. 1 and 2, the holder 8 is fastened to the base plate 10 of the vehicle 3, for example by spot welding or another suitable fastening method. The holder 8 can, however, also be dispensed with and, instead, the fastening bolt 7 can be fastened to the base plate 10 of the spare wheel recess 1, e.g. can be detachably fastened.

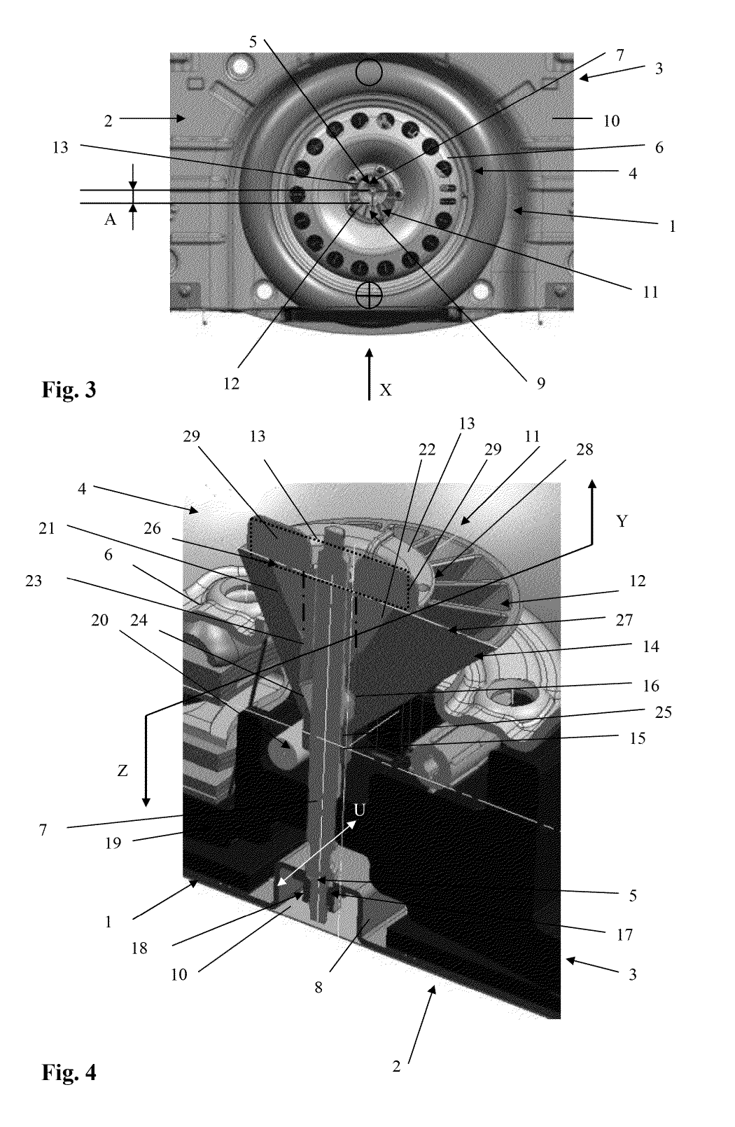

FIG. 3 now shows a top view of the spare wheel recess 1 according to FIGS. 1 and 2, wherein the spare wheel 4 is fastened to the vehicle 3 in the spare wheel recess 1 here by means of an embodiment of a fastening device 11. In order to fulfill the requirements of a so-called rear crash test or an impact test from the rear onto the vehicle 3, during an impact from the rear onto the vehicle 3, as indicated by an arrow X in FIG. 3, the spare wheel 4 should not inadvertently become detached from its fastening in the spare wheel recess 1 and move, for example, in the direction of the passenger compartment.

In an exemplary embodiment, the fastening device 11 can load at least two different spare wheels, which e.g. have different dimensions such as e.g. different external dimensions or external diameters, which lead to the fact that a spare wheel 4 is arranged eccentrically to the fastening point in the spare wheel recess 1, as is shown in FIG. 3. Here, the fastening device 11 prevents an inadvertent detaching of the spare wheel 4 during an impact test from the rear onto the vehicle 3.

As is shown in the example embodiment in FIG. 3, the fastening device 11 has a fastening adapter 12, a fastening nut 13 and, optionally, a fastening bolt 7, for fastening the spare wheel 4 in the spare wheel recess 1 of the vehicle 3. The fastening bolt 7 can, however, also be part of the spare wheel recess 1 and can be arranged thereon for example detachably or securely.

The fastening adapter 12 has a conical section 14 and, optionally, a cylindrical section 15 at its lower end. The conical section 14 and the cylindrical section 15 have a shared continuous opening 16, for the guiding through of the fastening bolt 7. The conical section is preferably constructed without gradations and has a flat or plane surface of the respective outer wall, as is shown in the following FIG. 4. Thereby, in the case of an impact on the conical section of the fastening adapter, the spare wheel can tilt around the fastening bolt, as is shown in the following FIG. 4.

The longitudinal axis of the opening is offset to the central point of the conical section 14 by a distance A*. This distance A* corresponds here to the distance A by which the center of the rim 6 of the spare wheel 4 is offset or spaced from the fastening point on the spare wheel recess 1. In this way, as shown in the top view in FIG. 3, the eccentrically arranged spare wheel 4 can be fastened by the fastening adapter 12 at the fastening point on the spare wheel recess 1. For this, the fastening bolt 7 is guided through the opening of the fastening adapter 12 and is screwed into a bore with a thread in the fastening point of the spare wheel recess 1. The fastening nut 13 is then screwed onto a thread section of the fastening bolt 7 and the fastening adapter 11 is moved and pressed against the rim 6 of the spare wheel 4.

The conical section 14 of the adapter 12 permits here that, when another vehicle impacts from the rear onto the vehicle 3 with the spare wheel 4, as is indicated by the arrow X in FIG. 3, the spare wheel 4 can tilt around the fastening bolt 7 on the conical section of the fastening adapter 12. As is indicated in FIG. 3 by arrow symbols, the spare wheel 4 tilts in the front region for example upwards in the direction of the vehicle roof and in the rear region correspondingly downwards in the direction of the vehicle floor.

In FIG. 4 a perspective view, partially in section, is shown of the fastening of the spare wheel 4 according to FIG. 3 by means of the fastening device 11. Here, the spare wheel 4, as previously illustrated in FIG. 3, is arranged eccentrically to the fastening bolt 7 in the spare wheel recess 1. The fastening bolt 7 is fastened, e.g. detachably, on the holder 8. The holder 8 is fastened here for example by spot welding on the base plate 10 of the trunk 2 of the vehicle 3 and has a bore 18 with a thread section 17, in order to form the fastening point 5 for the fastening bolt 7 in the spare wheel recess 1. The fastening bolt 7 can be screwed into this bore 18 with thread section 17 and can thus be detachably fastened on the holder 8.

In the example embodiment shown in FIG. 4, the spare wheel recess 1 has in addition a mount 19 for tools, which is arranged in the spare wheel recess 1 beneath the spare wheel 4 and serves for holding for example a jack 20 etc. The mount 19 is made for example from polystyrene. It can, however, also equally be omitted. The spare wheel 4 can be fastened by means of the fastening device 11 independently of this mount 19 for tools in the spare wheel recess 1.

For fastening the spare wheel 4, which is arranged eccentrically to the fastening point 5 or the bore 18 of the holder 8, after the screwing in of the fastening bolt 7 into the holder 8, the fastening adapter 12 is pushed onto the fastening bolt 7. The fastening nut 13 is then screwed onto the fastening bolt 7, wherein the fastening adapter 12 can be screwed by means of the nut 13 securely against the rim 6 of the spare wheel 4. Hereby, the spare wheel 4 can be fastened securely in the spare wheel recess 1. Owing to the conical section 14 of the fastening adapter 12, in the case of an impact onto the vehicle 3 from the rear the spare wheel 4 can move upwards with its front end for example, as is indicated by an arrow Y in FIG. 4, and can move downwards with its rear end, as is indicated by an arrow Z in FIG. 4, or vice versa, according to the impact. Thereby, lesser forces are transferred to the fastening bolt 7 and a tearing off of the fastening bolt 7 is counteracted. The conical section 14 of the fastening adapter 12 preferably has a flat or plane surface, i.e. the conical section is preferably not constructed so as to be graduated.

Optionally in addition the fastening bolt 7, as is shown in the example embodiment in FIG. 4, can have at its lower end, by which the fastening bolt 7 is fastened to the spare wheel recess 1, a section 21 with a thinner cross-section or smaller diameter. The latter serves for the fastening bolt 7 in this region, as is indicated by an arrow U in FIG. 4, to be able to be bent in one or other direction when the spare wheel 4 tilts in the case of an impact from the rear onto the vehicle 3. Likewise, the fastening bolt 7 can also have a continuously constant cross-section (not illustrated).

As is shown in the example embodiment in FIG. 4, the fastening adapter 12 has a continuous opening 16, through which the fastening bolt 7 is guided. The opening 16 has at its upper end for example a conical section 21, in which a conical section 22 of the fastening nut 13 is able to be received. Following the conical section 21, the opening 16 has, for example, a first cylindrical section 23, which e.g. has a greater diameter than the fastening bolt 7. Following the first cylindrical section 23, optionally a conical transition section 24 can be provided. Furthermore, a second cylindrical section 25 is provided, which serves for positioning the fastening adapter 12 on the fastening bolt 7. This cylindrical section 25 has the same diameter as the fastening bolt 7, so that the fastening adapter 12 can be guided on the fastening bolt 7.

Likewise, the opening 16 of the fastening adapter 12 can, however, also be provided as a through-bore, the diameter of which is equal to the diameter of the fastening bolt 7. In this case, the fastening nut 13 is not received in the opening 16 of the fastening adapter 12, but rather is constructed such that it lies with its underside 26 at the top on the fastening adapter 12, as is indicated by a dotted line in FIG. 4, wherein it is screwed onto the fastening bolt 7 and is screwed against the upper side 27 of the fastening adapter 12, in order to press the latter against the rim 6 of the spare wheel 4 and to thus fasten the latter in the spare wheel recess 1 of the vehicle 3.

Furthermore, the opening 16 can also have a cylindrical section instead of a conical section 21, as is indicated by a dot-and-dash line in FIG. 4, in which in this case, instead of the conical section 21, a correspondingly cylindrical section of the fastening nut 13 is able to be received (not illustrated).

As is shown in the example embodiment in FIG. 4, the fastening nut 13 can optionally have in addition a support surface 28, by which the fastening nut 13 can rest on the upper side 27 of the fastening adapter 12 when the fastening nut 13 is screwed on the fastening bolt 7 and is screwed against the fastening adapter 12, in order to press the fastening adapter 12 against the rim 6 of the spare wheel 4.

Furthermore, the fastening nut 13 can be optionally provided with one or more additional wings 29, as shown in the example embodiment in FIG. 4, or other elements, by means of which a user can easily actuate the fastening nut 13 by hand, without having to use an additional tool for this, such as for example a spanner.

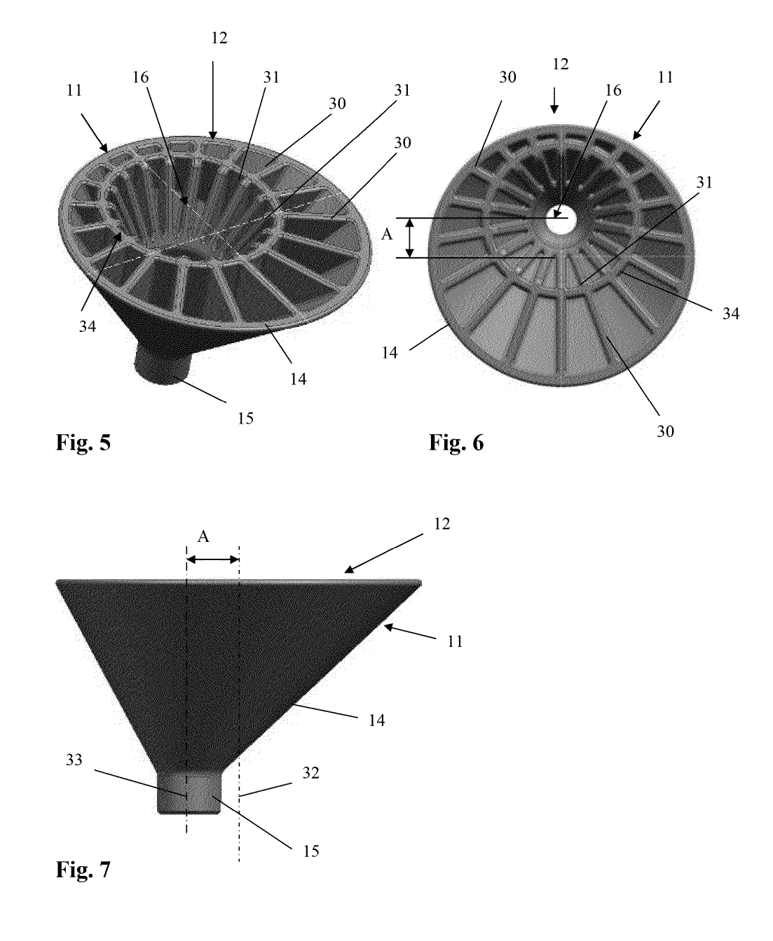

In FIG. 5 a perspective view is shown of the fastening adapter 12 of the fastening device 11 in accordance with FIG. 4. The fastening adapter 12 is constructed for example so as to be at least partially hollow and has several reinforcing ribs 30. As is shown in the example embodiment in FIG. 5, reinforcing ribs 30 can be optionally additionally connected with each other. For this, the fastening adapter 12 has an inner wall 34, for example a conical inner wall 34, which connects the ribs 30 with each other.

The ribs 30 can project with their ends 31 beyond the inner wall 34, as is shown in the example embodiment in FIG. 5, and form the conical section 21 to receive the conical section 22 of the fastening nut 13, as was previously shown in FIG. 4. Likewise, however, the ribs 30 can also terminate with their ends at the inner wall 34. The inner wall 34 then forms the conical section of the opening 16 of the fastening adapter 12 to receive the conical section 22 of the fastening nut 13.

The connection of the ribs 30 by the inner wall 34 brings it about that the ribs 30 cannot be inadvertently pressed apart and thereby for example can be configured so as to be somewhat thinner. Furthermore, the inner wall 34 and/or the ribs 30 can have the same height, as in the example embodiment in FIG. 5, or can have a different height (not illustrated) so that the fastening nut 13 can rest with its support surface 28 on the inner wall 34 of the fastening adapter 12 and/or the ribs 30.

By the fastening adapter 12 being constructed so as to be hollow by the rib structure 30, no or few cavities or pores can form in the fastening adapter 12, when the latter for example is constructed as a cast part or injection molded part of plastic or metal. Furthermore, savings can be made with regard to material and weight. The fastening adapter 12 can, however, likewise be produced partly or entirely as a solid part, including also as a solid cast part or injection molded part.

In FIG. 6 a top view is shown of the fastening adapter 12 according to FIG. 5. The fastening adapter 12 has the reinforcing ribs 30 which are connected with each other via the inner wall 34. The ribs 30 can terminate with the inner wall 34 (not illustrated) or can project with their ends 31 beyond the latter into the opening 16 of the fastening adapter 12 and form a contact surface for the conical section of the fastening nut.

As is shown in FIG. 6, the longitudinal axis 32 of the conical section 14 of the fastening adapter 12 is offset to the longitudinal axis 33 of the opening 16 of the fastening adapter 12 or is spaced apart by the distance A. Thereby, as previously described, a spare wheel 4, which is not arranged centrally to the fastening point 5 of the spare wheel recess 1 for the fastening bolt 7 can be fastened by the fastening adapter 12 in the spare wheel recess 1.

In FIG. 7 furthermore, a side view of the fastening adapter 12 according to FIGS. 5 and 6 is shown. Here, the longitudinal axis 33 of the conical section 14 of the fastening adapter 12 is offset by the distance A to the longitudinal axis 33 of the opening of the fastening adapter 12.

The conically constructed fastening adapter 12 of the fastening device 11 allows the spare wheel to be able to rotate or respectively tilt during an impact test from the rear or rear crash test. This rotation or respectively tilting permits the spare wheel fastening concept to fulfill the requirements of the impact test from the rear. The fastening adapter 12 allows the fastening of a spare wheel even when the fastening point of the spare wheel recess or depression in the vehicle lies outside the central point of the spare wheel.

The fastening device 11 can be manufactured at a very favorable price and is simple and quick to install, so that it is particularly user-friendly. In addition, the fastening device constitutes a very robust fastening for a spare wheel in a vehicle, without additional bands being necessary to hold the spare wheel and to fulfill the requirements of the impact test from the rear.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment, it being understood that various changes may be made in the function and arrangement of elements described in an exemplary embodiment without departing from the scope of the invention as set forth in the appended claims and their legal equivalents.

What is claimed is:

1. A fastening adapter for fastening a spare wheel in a spare wheel recess of a vehicle, the fastening adapter comprising:
a conical section configured for guiding a fastening element through an opening of the fastening adapter, wherein the longitudinal axis of the conical section is offset to a longitudinal axis of the opening.

2. The fastening adapter according to claim 1, wherein the opening has a mount configured to receive a fastening nut.

3. The fastening adapter according to claim 1, wherein the opening has a cylindrical section configured for guiding the fastening element into the opening.

4. The fastening adapter according to claim 1, wherein the fastening adapter has a plurality of reinforcing ribs, each having an end.

5. The fastening adapter according to claim 4, wherein the plurality of reinforcing ribs is connected via an inner wall and project with the ends beyond the inner wall to form a section for receiving the fastening element.

6. The fastening adapter according to claim 5, wherein the ends of the plurality of reinforcing ribs form a support for the fastening element.

7. The fastening adapter according to claim 4, wherein the plurality of reinforcing ribs is connected via an inner wall and terminates with the ends at the inner wall and the inner wall forms a section for receiving the fastening element.

8. The fastening adapter according to claim 7, wherein the inner wall forms a support for the fastening element.

9. The fastening adapter according to claim 1, wherein the fastening adapter is constructed as a cast part or as an injection molded part.

10. The fastening adapter according to claim 1, wherein the fastening adapter is formed from metal or plastic.

11. A fastening device comprising:
a fastening nut having a conical section; and
a fastening adapter having a conical section configured for guiding the fastening nut through an opening of the fastening adapter, the conical section of the fastening adapter configured to receive the conical section of the fastening nut, wherein a longitudinal axis of the conical section of the fastening adapter is offset to a longitudinal axis of the opening.

12. The fastening device according to claim 11, wherein the fastening nut has a support surface for resting on an upper side of the fastening adapter.

13. The fastening device according to claim 11, wherein the fastening nut has at least one wing configured so as to actuate the fastening nut manually.

14. The fastening device according to claim 11, further comprising a fastening bolt configured for fastening the fastening nut on the fastening adapter.

15. The fastening device according to claim 14, wherein the fastening bolt has a section with a reduced diameter for bending the fastening bolt.

16. The fastening device according to claim 14, wherein the fastening bolt has an opening with a thread configured for receiving the fastening nut.
